(19) United States
(12) Patent Application Publication
(10) Pub. No.: US 2007/0162643 A1
(43) Pub. Date: Jul. 12, 2007

(54) FIXED OFFSET SCATTER/GATHER DMA CONTROLLER AND METHOD THEREOF

(76) Inventor: Ivo Tousek, Stockholm (SE)

Correspondence Address: BAKER & MCKENZIE LLP, Pennzoil Place, South Tower, 711 Louisiana, Suite 3400, HOUSTON, TX, 77002-2716, US

(21) Appl. No.: 11/467,471

(22) Filed: Aug. 25, 2006

Related U.S. Application Data
(60) Provisional application No. 60/751,718, filed on Dec. 19, 2005.

(51) Int. Cl. G06F 13/28

(52) U.S. Cl. 710/22

(57) ABSTRACT

The invention disclosed herein is directed to a scatter/gather direct memory access (DMA) controller that is able to perform DMA data transfers from/to noncontiguous areas in a memory to/from contiguous areas in a memory. The DMA controller has a control register comprised of three fields, a line segment offset, a line size and a line count, respectively, to efficiently control an imaging data transfer using a fixed-offset manner. The line segment offset field sets a fixed offset value to the next line segment in a memory, the line size field sets the size of the line segment, and the line segment count field counts the number of line segments remaining in a DMA transfer.

This application claims the benefit of U.S. Provisional Application No. 60/751,718 filed Dec. 19, 2005.

### BACKGROUND OF THE INVENTION

1. Field of the Invention

This invention relates to data transfers in systems and more particularly to a scatter/gather direct memory access (DMA) controller which is able to perform DMA data transfers from/to noncontiguous areas in memory to/from contiguous areas in memory.

2. Description of the Related Art

The transfer of data between paged mode access primary storage and secondary storage in the form of a data storage device is advantageously performed by DMA, which is a technique for moving data by means of a DMA controller, without any interaction from a processor. DMA operations are initiated by the processor, but do not require the processor for the data transfer. A DMA device is a device which incorporates a DMA controller and is thus able to transfer data directly from the disk to a primary storage by DMA.

Scatter/gather DMA controllers provide flexible scatter gather features. A general scatter/gather DMA controller reads configuration information from a linked list of descriptors, which describe the DMA transfers of a number of data segments which all form part of a bigger scatter/gather DMA transfer. A flexible, however, complex solution is if the scatter/gather list of descriptors is implemented as a linked list in memory. A simple, however, costly solution is if the scatter/gather list entries are stored locally in the DMA channel's configuration registers. In both those cases, it may be a complex task which may take many clock cycles for the processor to configure all descriptor values associated with complex scatter/gather DMA transfers. Therefore, there is a need for a scatter/gather DMA controller that is flexible, simple for the processor to configure, simple to implement and yet inexpensive.

### SUMMARY OF THE INVENTION

The invention disclosed herein is directed to a scatter/gather DMA controller that is able to perform DMA data transfers from noncontiguous areas in memory to a contiguous area in memory, or from a contiguous area in memory to noncontiguous areas in memory in a regular fashion

One aspect of the present invention contemplates a control register for a scatter/gather DMA controller. The control register comprises three fields: a line segment offset, a line segment size and a line segment count. The line segment offset field sets a fixed address offset to the next line segment in memory, the line segment size field sets the size of the line segment, and the line segment count field counts the number of line segments remaining in a DMA transfer.

Another aspect of the present invention provides a data processing apparatus which comprises a DMA controller which transfers data between different address ranges in memory. The DMA controller provides a fixed-offset scatter/gather configuration register to support multiple line segments of data to be transferred from (non-)contiguous areas in one memory address range to (non-)contiguous areas in another memory address range.

Yet another aspect of the present invention provides a method of transferring data with a fixed-offset scatter/gather DMA controller. The method comprises the steps of providing a set of parameters in a control register of the DMA controller, wherein said parameters comprising a line segment address offset field, a line segment size field, and a line segment count field, transferring a first line segment from one address range to another address range and decrementing the line segment count field, transferring a second line segment based on the line segment offset field and the line size field and decrementing the line segment count field, and repeatedly transferring line segments until the line segment count field is zero.

### BRIEF DESCRIPTION OF THE DRAWINGS

The accompanying drawings are included to provide a further understanding of the present invention, and are incorporated in and constitute a part of this description. The drawings illustrate embodiments of the present invention, and together with the description, serve to explain the principles of the present invention. There is shown:

FIG. 1 illustrates a schematic diagram of a fixed-offset scatter/gather DMA transferring data between different memory address ranges through a DMA controller according to a preferred embodiment of the present invention;

FIG. 2 illustrates the control register fields according to a preferred embodiment of the present invention;

FIG. 3 illustrates a macro block with line segments scattered in memory according to a preferred embodiment of the present invention;

FIG. 4 illustrates the control register fields according to another preferred embodiment of the present invention; and

FIG. 5 illustrates a sequence of macro blocks, each with line segments scattered in memory according to another preferred embodiment of the present invention.

### DESCRIPTION OF THE PREFERRED EMBODIMENTS

The invention disclosed herein is directed to a scatter/gather DMA controller which is able to perform DMA data transfers from/to noncontiguous areas in memory to/from contiguous areas in memory. In the following description, numerous details are set forth in order to provide a thorough understanding of the present invention. It will be appreciated by one skilled in the art that variations of these specific details are possible while still achieving the results of the present invention. In other instances, well-known backgrounds are not described in detail in order not to unnecessarily obscure the present invention.

One of the aspects of the present invention is to use a fixed-offset scatter/gather DMA controller which is very efficient in terms of software configuration, implementation cost and DMA performance when data segments need to be transferred to/from memory in a noncontiguous but regular fashion.

Referring now to FIG. 1, there is a schematic diagram illustrating a series of scatter/gather DMA transfers between different memory address ranges through a DMA controller according to a preferred embodiment of the present invention. This example shows a one-way scatter/gather feature, meaning that data segments (W0, W1, W2, W3) can be gathered from or scattered in one end of the DMA transfer (memory A 102), while all data in the other end of the DMA transfer (memory B 104) resides in contiguous memory locations as shown in the Figure. The data transfers between different memory address ranges are controlled by the DMA controller 106.

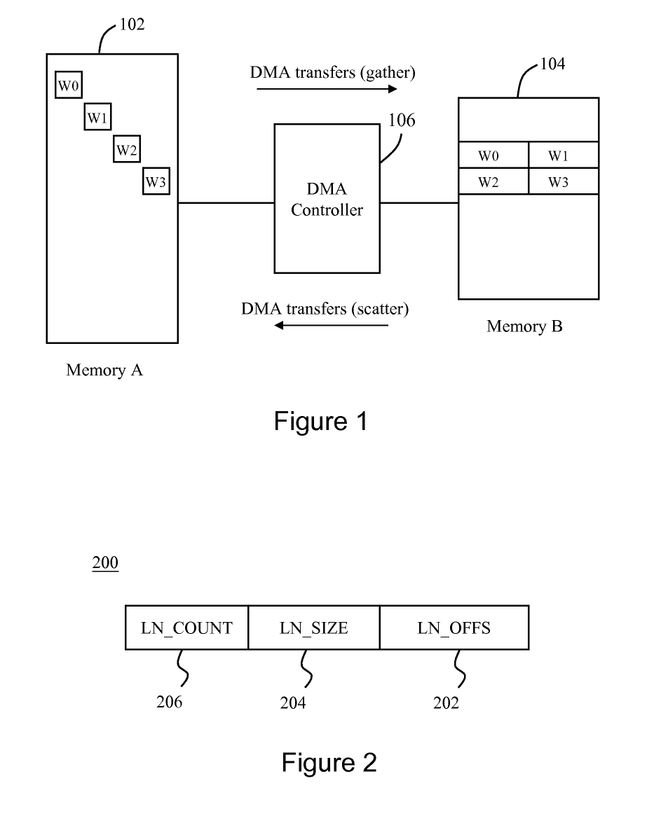

Referring now to FIG. 2, there is shown an example of a DMA controller register configuration according to a preferred embodiment of the present invention. This example implements the fixed offset scatter/gather DMA function by the addition of a single register to each DMA channel's set of control registers in the DMA controller. The DMA control register 200 comprises three fields to represent line segment offset, line segment size, and line segment counts, respectively. The first field is a 16-bit line segment offset (LN_OFFS) 202 which holds the address offset in 4-byte words from the end of a line segment to the beginning of the next line segment in memory. The second field is an 11-bit line segment size (LN_SIZE) 204 which holds the size of each line segment. The third field is a 5-bit line segment count (LN_COUNT) 206 which holds a down-counter value corresponding to the total number of line segment DMA transfers remaining beyond the current one.

Initially, programming the LN_COUNT field 206 to a value greater than 0 will enable the scatter/gather feature. Setting the LN_COUNT value to n indicates that the overall DMA service over the channel will consist of n+1 line segment transfers in total. Other methods of implementation will be readily apparent to one skilled in the art. When the first line segment transfer has been completed, LN_OFFS will be added to the current memory address in scatter/gather memory (memory A 102), LN_SIZE will be written into the transfer size register, and LN_COUNT will be decremented by one. The overall DMA transfer is done when the last line segment has been transferred and LN_COUNT is zero. Note that in the embodiment, the transfer size register is decremented during the transfer. The scenario indicated is preferably implemented in imaging applications, for example, MPEG and JEPG decoding/encoding. Such applications work on pixel data arranged in macro blocks corresponding to a square portion of the image.

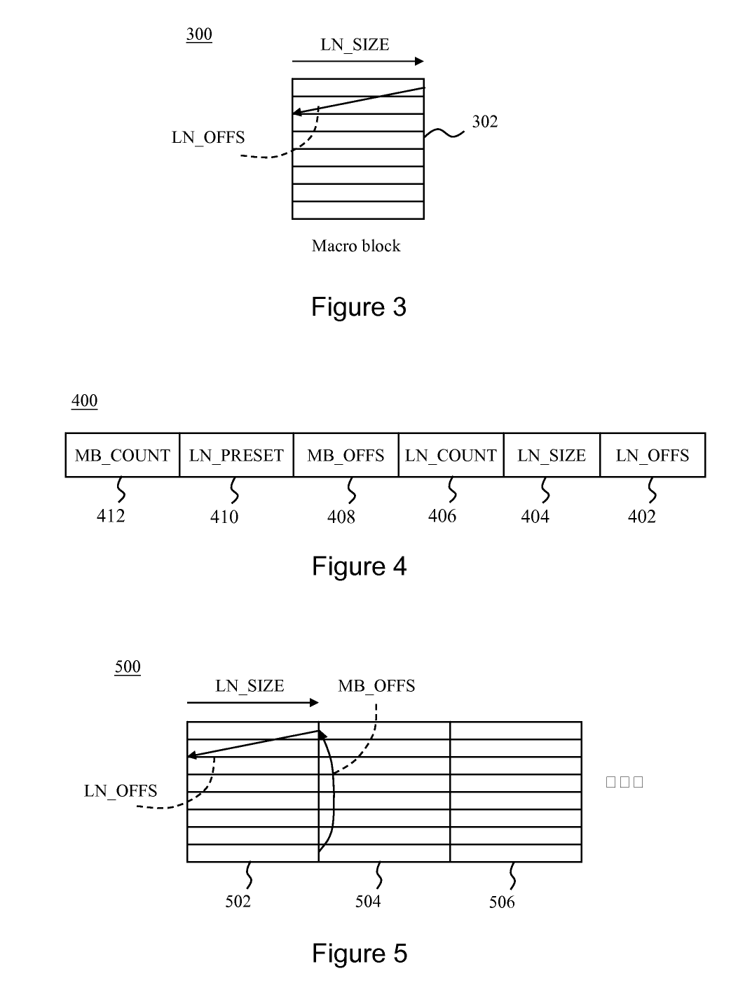

Referring now to FIG. 3, there is shown a schematic diagram showing how data associated with one macro block can be scattered in memory according to a preferred embodiment of the present invention. In one embodiment, the image pixel data as described above are typically arranged in macro blocks 302 corresponding to a square portion of the image in a memory 300, as indicated in FIG. 3. Each such macro block 302 contains image data associated with a number of image line segments, in one example, 8 line segments per macro block. Alternatively, other numbers, e.g. 16 or 32 line segment per macro block can also be used.

Compressed image data is typically organized macro block wise in a memory B (shown in FIG. 1), from the top left hand corner of the image. Uncompressed image data (raw pixel data) on the other hand, is typically stored line by line, starting from the top left hand corner of the image in a memory A 300. Hence, line segments associated with one macro block 302 are stored with constant intervals in the complete raw image.

As an example, assume that compressed image data loaded into memory A shall be decoded by a digital signal processor (DSP) and stored back to a frame buffer in memory A for display on an LCD panel. The LCD controller reads raw pixel data from the frame buffer one line at a time, starting from the top left corner of the display. Macro blocks of compressed image data residing on contiguous addresses in memory A are transferred linearly via DMA over to memory B for decoding by the DSP. The DSP decodes the different macro blocks and places the raw pixel data on contiguous addresses in memory B. Then, the individual line segments of decoded pixel data belonging to one macro block can be transferred to the frame buffer via the DMA scatter feature back to the memory A.

As a further enhancement, the fixed offset scatter/gather DMA register of the present invention may add more channel configuration parameters to make it more powerful and flexible. In that way, multiple macro blocks can be transferred between two memories in one single channel configuration.

Referring now to FIG. 4, there is shown an example of a DMA controller register configuration according to another preferred embodiment of the present invention. This example implements the fixed offset scatter/gather DMA function by the addition of a single register to each DMA channel's set of control registers in the DMA controller. The DMA control register 400 comprises three fields to represent line segment offset 402, line segment size 404, and line segment count 406, respectively as described before. The first field is a 16-bit line segment offset (LN_OFFS) 402 which holds the offset in 4-byte words to the next line segment in the memory. The second field is an 11-bit line segment size (LN_SIZE) 404 which holds the size of the line segment. The third field is a 5-bit line segment counter (LN_COUNT) 406 which holds a down-counter value corresponding to the total number of line segment transfers remaining beyond the current one. Additional three fields 408, 410, 412 are used to represent macro block offset, macro block size, and macro block count, respectively. The fourth field is a 16-bit line macro offset (MB_OFFS) 408 which holds the address offset from the end of the previous macro block to the start of the next macro block in the memory. The fifth field is a 5-bit macro block size (LN_PRESET) 410 which holds a value corresponding to the number of line segments in each macro block. The sixth field is an 8-bit line macro block count (MB-COUNT) 412 which holds a down-counter value corresponding to the number of macro blocks remaining in the overall DMA transfer.

Initially, programming the MB_COUNT to a value greater than 0 will enable the scatter/gather feature for multiple macro blocks. Setting the MB_COUNT value to n indicates that the overall DMA service over the channel will consist of n+1 macro block transfers in total. Other configurations will be readily apparent to one skilled in the art.

Referring now to FIG. 5, there is shown a schematic diagram showing how scatter data with a sequence of macro blocks indicated are transferred according to another preferred embodiment of the present invention. In one embodiment, when a complete macro block, i.e. macro block 502, has been completely transferred from a memory A 500, the MB_OFFS value is decremented from the current memory A address to the next macro block 504, the LN_PRESET value is copied to LN_COUNT, and MB_COUNT is decremented by one. The overall DMA transfer is done when the last line segment (LN_COUNT equals to zero) of the last macro block (MB_COUNT equals to zero) has been transferred.

One may note that out of the six scatter/gather parameters, only the counters (LN_COUNT and MB_COUNT) are changing states during a DMA transfer, while the others remain unchanged. By grouping the counters into the same channel register and the fixed parameters into other registers, then scatter/gather DMA transfers of contiguous macro blocks can be programmed by simply reprogramming the start address to the first macro block in a sequence of macro blocks and by enabling the two counter values.

Although the present invention has been described in considerable detail with references to certain preferred versions thereof, other versions and variations are possible and contemplated. For example, the number of bits implemented in LN_OFFS field can be changed to other numbers than the exemplary embodiment, for example, 12 bits. Moreover, although the present disclosure contemplates one implementation using three fields to form a DMA control register configuration, it may also be applied in a similar manner to achieve the same effect taught in the present invention, such as using two or four fields to form a DMA control register configuration or the like.

According to the above mentions, from a software programming perspective, the fixed-offset scatter/gather DMA controller is much simpler to configure than the general scatter/gather DMA Controller, and from a processor performance perspective, the fixed-offset scatter/gather DMA controller is much faster to configure than the general scatter/gather DMA controller.

Finally, those skilled in the art should appreciate that they can readily use the disclosed conception and specific embodiments as a basis for designing or modifying other structures for carrying out the same purpose of the present invention without departing from the spirit and scope of the present invention as defined by the appended claims.

What is claimed is:

1. A control register for a scatter/gather DMA controller, comprising:
a line segment offset field, storing a fixed offset value to a next line segment in a memory;
a line segment size field, storing the size of the next line segment; and
a line segment count field, counting a number of line segments remaining in a DMA transfer.

2. The control register for a scatter/gather DMA controller according to claim 1, further comprising at least one macro block field.

3. The control register for a scatter/gather DMA controller according to claim 2, wherein said macro block field comprises:
a macro offset field, storing an offset value from an end of a previous macro block to a start of next macro block in the memory;
a line preset field, storing a number of line segments in each macro block; and
a macro block count field, counting the number of macro blocks remaining in the DMA transfer.

4. The control register for a scatter/gather DMA controller according to claim 1, wherein said DMA transfer is an imaging data transfer.

5. The control register for a scatter/gather DMA controller according to claim 4, wherein said imaging data is MPEG data.

6. The control register for a scatter/gather DMA controller according to claim 4, wherein said imaging data is JPEG data.

7. A method of transferring data with a scatter/gather DMA controller, comprising:
providing a set of parameters in a register of the DMA controller, wherein said parameters comprising a line segment offset field, a line size field, and a line segment count field;
transferring a first line segment from one address range to another address range;
decrementing the line segment count field;
transferring a second line segment based on the line segment offset field, and the line size field;
decrementing the line segment count field; and
repeatedly transferring data until the line segment counter field is zero.

8. The method according to claim 7, wherein said line segment offset field is fixed.

9. The method according to claim 8, wherein said data is imaging data.

10. The method according to claim 9, wherein said imaging data is MPEG data.

11. The method according to claim 9, wherein said imaging data is JPEG data.

12. A method of transferring data with a scatter/gather DMA controller, comprising:
providing a set of parameters in a register of the DMA controller, wherein said parameters comprises a macro block offset field, a macro block count field, a line segment offset field, a line size field, and a line segment count field;
transferring a first macro block between a scatter memory and gather memory;
decrementing the macro block count field;
transferring a second macro block based on the macro block offset field;
decrementing the line segment count field; and
repeatedly transferring data until the line segment count field and the macro block count filed are both zero.

13. The method according to claim 12, wherein said parameters further comprises a line preset field storing the number of line segments in each macro block.

14. The method according to claim 12, wherein said macro block offset and the line segment offset are fixed.

15. The method according to claim 12, wherein said data is imaging data.
